(19) United States
(12) Patent Application Publication
(10) Pub. No.: US 2009/0007930 A1
(43) Pub. Date: Jan. 8, 2009

(54) DENTAL FLOSSING DEVICE AND ITS FABRICATION AND USE

(76) Inventor: JAMES C. FENG, PASADENA, CA (US)

Correspondence Address: JAMES FENG;UNIT #4, 201 SOUTH CATALINA AVE., PASADENA, CA, 91106, US

(21) Appl. No.: 12/142,768

(22) Filed: Jun. 19, 2008

Related U.S. Application Data
(60) Provisional application No. 60/958,235, filed on Jul. 3, 2007.

(51) Int. Cl. A61C 15/04

(52) U.S. Cl. 132/323

(57) ABSTRACT

A dental flossing device that aids proper oral hygiene between teeth without exerting manual forces. The accordion-like structure of the head unit attaches a floss filament bow of fixed dimension which then attaches to a handle. The unique head unit of the device facilitates the passing of the flossing filament through the contact areas between teeth utilizing biting forces than those of the hands and arms. Accordingly, this eliminates the need to require manual dexterity and exertion while flossing. The retractable head unit can be fabricated using a spring-like mechanism which allows it to collapse and return to its original shape or it may be automated using electrical power.

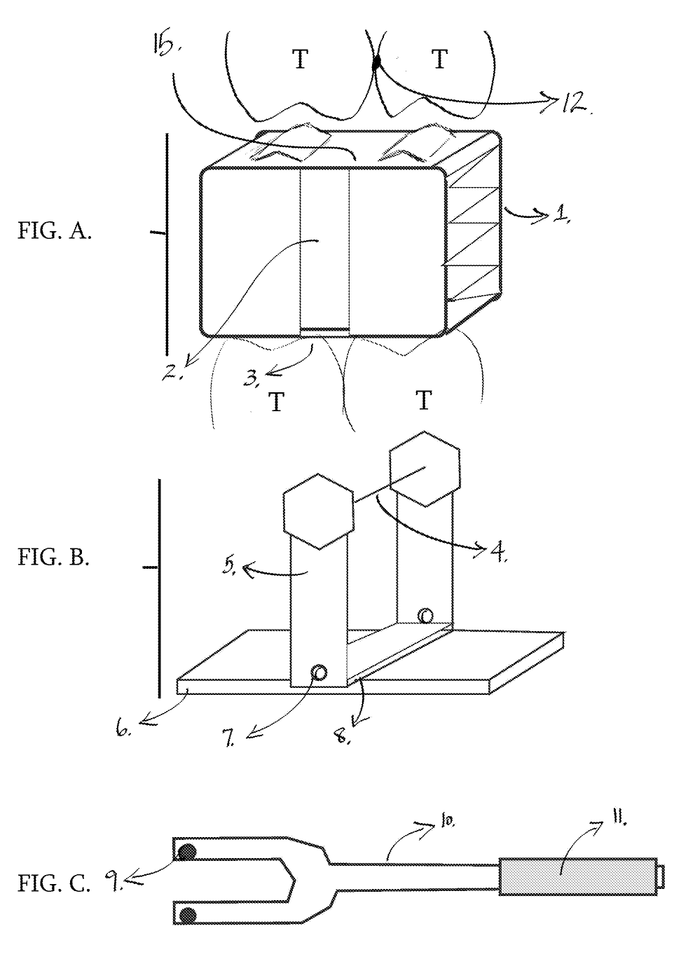

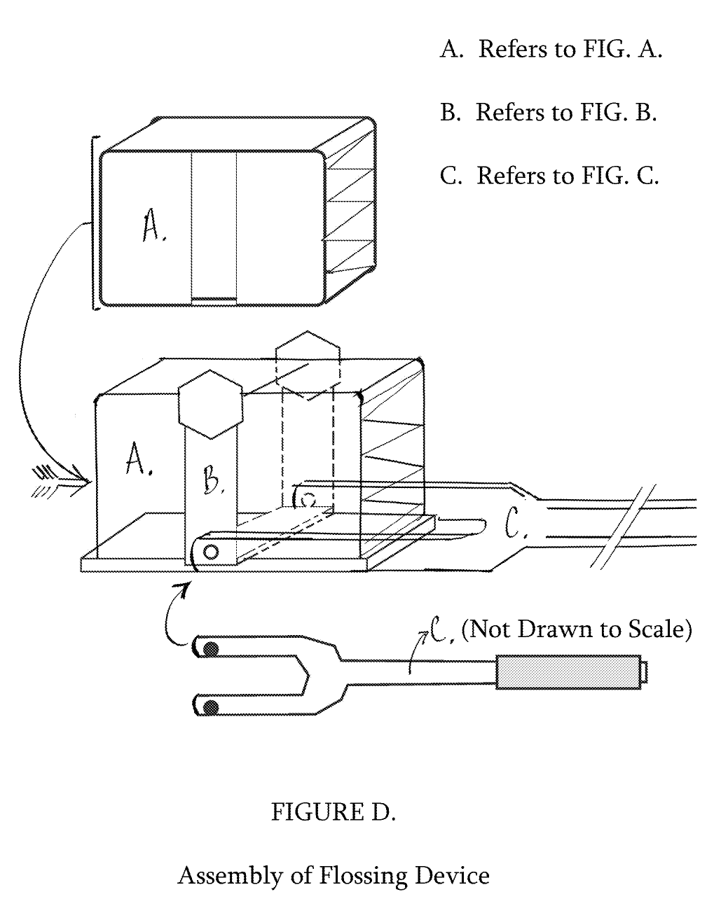

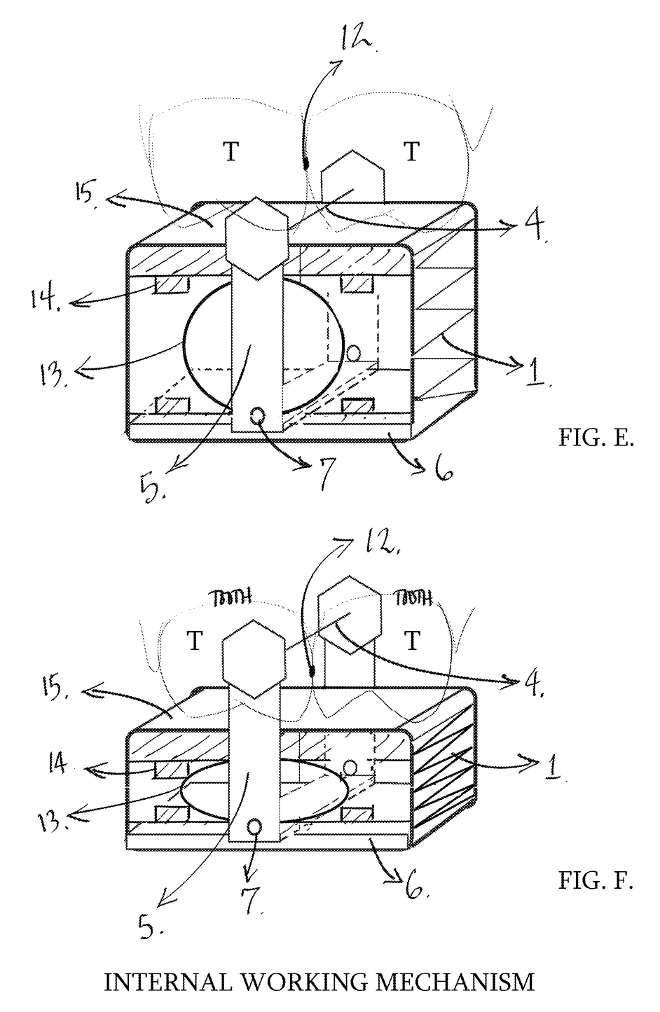

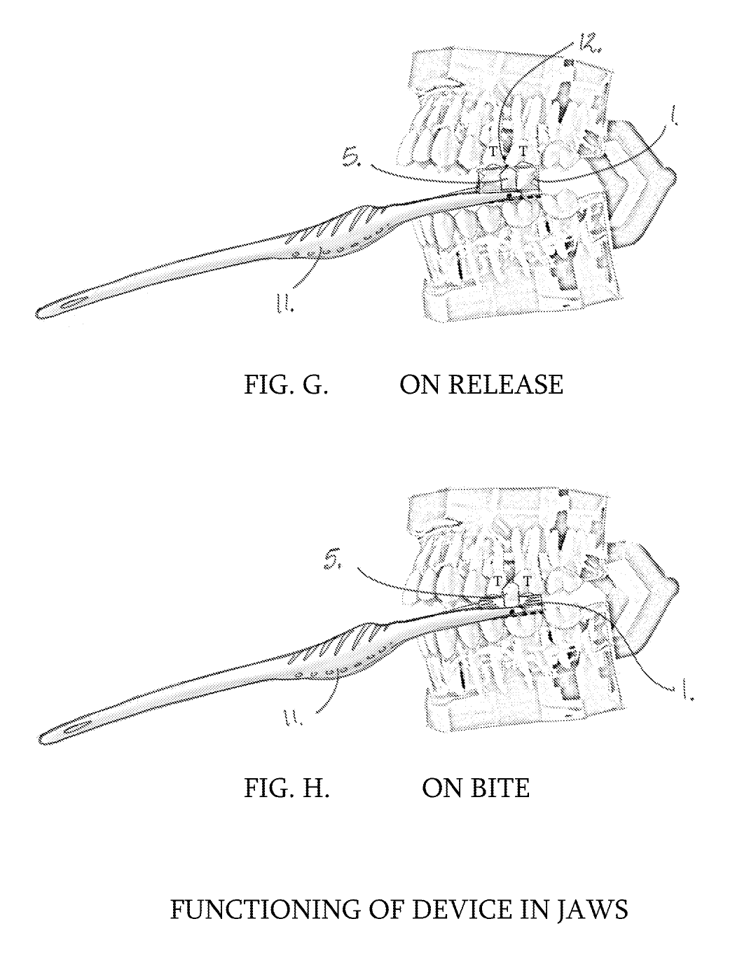

### FIELD OF THE INVENTION

The present invention relates to oral hygiene tools and aids. More particularly, the device and methodology of the invention enables single handed flossing operation with minimal manual dexterity and forces needed. Instead of floss being pushed in-between teeth by hand, that force is exerted by biting down on the device.

### BACKGROUND OF THE INVENTION

Oral hygiene aids are utilized for proper maintenance of the cleanliness of teeth. It is a common fact that flossing is an important part of good oral hygiene. The lack of flossing or inadequate frequency may lead to dental caries, periodontal disease, halitosis, and other dental/oral conditions. The utilities of the floss and flossing tools are cleansing areas between teeth that a toothbrush cannot reach. Two such important such areas are the teeth and the gums between teeth. Interproximal contacts, where two teeth touch on their sides, are areas where bacterial plaque can accumulate and cause decay to form between teeth. Gingival embrasure spaces are those spaces between the gums and teeth's root surfaces immediately below the interproximal contact areas. These areas, when subject to bacterial plaque and tartar, leave the gums susceptible to gum disease.

Although many people incorporate dental flossing as regular part of daily oral care, there are still significant populations who do not floss. There are many reasons for an individual to not flossing regularly. Some of those reasons are include lack of time, laziness, not habit forming, forgetfulness, hyper ‘gag’ reflex, lack of manual dexterity, or the inability to exert force necessary to push floss in-between all teeth and pull it out. The current invention attempts to address the latter three of the above listed reasons.

Conventional flossing involves a length of floss filament wrapped around fingers of both hands. With practice, the hands and fingers work in unison to push the floss filament pass the contact areas between teeth to remove bacterial plaque. Those individuals with anatomically tighter contacts between teeth find themselves exerting more manual force to accomplish the task of flossing. Added to the difficulty is for certain individual to extend the hand/finger/floss assembly all the way posterior to reach back molars. This becomes even more cumbersome in individuals with large hands and fingers.

Many different flossing devises have been available in attempt to address those issues. However, current dental flossing devices facilitate flossing only after manual manipulation of flossing filament through the contact points between teeth. An example includes any various designs consisting of a handle on one end, and the other end consisting of a bow or harp-like floss assembly. User of this type of flossing device needs to grip the handle as well as exert force to push the floss filament through the contact area between teeth. Then user has to pull the device out of the contact area to floss the next contact area. One example of conventional manual flossing device is disclosed in U.S. Pat. No. 5,483,982, the entire disclosure of which is incorporated herein by references. Two examples of commercially available mechanical/powered flossing device are disclosed in U.S. Pat. No. 5,573,020 and U.S. Pat. No. 5,279,314.

### BRIEF SUMMARY OF THE INVENTION

A dental flossing device consisting of (1.) a handle, (2.) a floss holding element of fixed dimensions and (3.) a biting element with a movable platform on which teeth are can bite. The handle (1.) functions like any handle that allows user to manipulate the device anywhere in the mouth. The floss holding element (2.) consists of a base and two perpendicular extension arms that hold a piece of floss. The head unit (3.) consists of two biting platforms (one for upper teeth and one for opposing lower teeth) with a spring-type mechanism in between in an accordion style assembly and has a coupling mechanism for the flossing holding element to attach.

As the platform of the biting element moves up and down, the fixed height flossing element exposes the floss filament and in relative movement, enters the contact point between teeth. The upper and lower jaws/teeth maintain contact on the base and the movable platforms of the biting element/floss element assembly during this process. Depending on which jaw the floss filament is facing, it is possible to floss in-between any teeth, maxillary or mandibular. Once the floss filament enters the contact, bacterial plaque and debris is removed at the susceptible cavity formation area in between teeth, known dentally as interproximal contact area as well as areas immediately below the contact area known dentally as the embrasure space. With the floss filament passed through and now beyond the contact area of two teeth, user can also manipulate the flossing element by moving the lower jaw back and forth to apply tension of the floss against the tooth, to cleanse the tooth and root surfaces that juxtaposes the gums as described in various pre-referenced prior art. In a reverse fashion, the dental flossing device protracts from the retracted position, facilitated by any form of spring (or mechanical in the case of the automated variation) retraction, thereby in relative motion, pulls the floss out of the interproximal contact. This is repeated as user flosses in between all teeth.

The nature of current invention is a flossing device that actually facilities the passing of flossing filament through the contact area between teeth by using the muscles of mastication instead of muscles of the hand and arm. Then as with use of prior art, the cleansing of teeth surfaces can be accomplished. This invention provides a method of flossing sometimes necessary for users who have difficulty manipulating floss through in-between teeth due to medical conditions or from age related incapacity. Also, if flossing is easier, more people would do it.

According to one aspect of the invention, a flossing device includes a handle attached to a head unit. The head unit has biting surfaces for the upper and lower teeth and is retractable as the teeth bite together onto it. Attached to the retractable head unit is a non-retractable floss holding bow with a floss filament across the bow. The fixed dimension of the floss holding element allows the floss filament move away from the biting surface of the head unit as the user bites. This force the floss filament to enter the interproximal contact as the rest of the head unit compresses or retracts. The retractable head unit of the flossing device may be fabricated from various types of spring-like mechanisms. In another aspect of the invention, it can be automated with electronic mechanisms that retracts and protracts the head unit independent from a spring-type that may fatigue over time.

The flossing device of the current invention requires minimal manual dexterity and is in consideration for the elderly as well as users with various medically compromised conditions that prohibit or hinders normal flossing. In contrast to conventional flossing or the use of other bow-type flossers, the flossing device of the invention virtually eliminates the need to exert excess force to push the flossing element through the interproximal areas. Some people develop conditions resulting from repetitive motion such as carpal tunnel syndrome or from age related disabilities such as severe arthritis. Those people can benefit from a flossing device that does not demand manual dexterity and strength. The invention uses biting force instead of hands and fingers forces to floss. The task of the hands and fingers is merely to position the floss element centered in between two teeth. Once positioned, all one needs to do to floss is bite down onto the device. Also individuals who injured their finger(s), hand(s), or wrist(s) can benefit from this invention. People who find themselves not motivated to floss due to lack of motivation may also benefit from this alternative device as it's easier to use. Children can also benefit from this invention to start early development of good flossing habits before full maturation of motor hand-eye coordination required for proper flossing. Finally, another advantage is lowering the gagging reflex for sensitive individuals due to its compact size.

In the powered version of this invention, the main feature becomes automated. Current powered dental flossing devices facilitate flossing after still requiring manual manipulation of flossing element through the contact points between teeth. Although the bow, or harp-like design allows for single handed operation, those designs still require manual manipulation; therefore not truly automated. In other powered floss device, floss-like cleansing tip is applied through the lateral embrasure spaces without ever passing floss through the contact point, leading to less than ideal flossing technique. True effective flossing occurs when the floss filament passes through the contact between two teeth with some resistance. Example of the former mentioned type of current marketed automatic flosser is again those with any various designs consisting of a powered handle at one end and the other includes a bow or harp-like floss assembly. An example of the latter consists of a handle with a brush head small enough to enter and clean the gingival embrasure, defined as the triangular space in-between two teeth bordered by the root surfaces, the gingiva and the interproximal contact. Although these devices facilitate the removal of plaque, they do not truly automate the process of manual flossing.

The nature of the mechanical version of the current invention is an automatic flosser that actually facilities the passing of flossing filament through the contact point. Then with use of prior art, the cleansing of teeth surfaces can be accomplished. This provides a twofold automation sometimes necessary for users who have difficulty manipulating floss through in-between teeth due to medical conditions such as arthritis or from age related incapacity. The first step automation is the facilitated passing of the floss through the contact areas with the retractable head unit. The second step automation is the vibratory action to loosen the bacterial plaque. Although the second step automation is not the focus of this invention because it has been described by prior art, the coexistence of the automations makes the latter more widely used.

There are current products available on the market but they have shortcomings associated with each. Some oral hygiene aid products claims to replace the floss by injecting high powered stream of water in the interproximal space or in another device, a vibrating micro-brush is used to push into the embrasure space. Those tools may have benefits in loosening and/or removing bacterial plaque in the embrasure space; however, the contact areas between the teeth are never broken as no physical solid contact by these devices are ever made at that critical contact area. This still leaves teeth prone to interproximal decay.

Other features and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

Figure A: Illustrates the Retractable Biting Head Unit

Figure B: Illustrates the Flossing Element

Figure C: Illustrates a Typical Handle

Figure D: Illustrates the Assembly of the Flossing Device from its three parts A., B. and C.

Figure E: Illustrates the Cross-section internal view of protracted Head Unit

Figure F: Illustrates the Cross section internal view of retracted Head Unit as teeth bite together

Figure G: Illustrates the Functioning of Device in Jaws at Rest

Figure H: Illustrates the Functioning of Device in Jaws on Biting (Note that on bite, flossing element exposes floss as biting unit retracts.)

Figure G: (repeat) Flossing Element/Head Unit returns to original shape on release of bite.

### DESCRIPTION OF PARTS

1. Collapsible/Accordion-like bite block
2. Fitting for Flossing element Arms (5.)
3. Opposing teeth
4. Floss filament
5. Flossing element arm
6. Base of flossing element
7. Attachment hole for handle
8. Protrusion that engages retractable head unit
9. Protrusion that engages part 7.
10. Neck of handle
11. Handle
12. Interproximal contact area to be flossed
13. Any form of spring
14. Protrusion that prevents overcompression of spring
15. Biting platform of retractable head unit

### DETAILED DESCRIPTION OF THE INVENTION

Referring more particularly to the drawings, the three components that make up the flossing device are illustrated in FIG. A, FIG. B, and FIG. C. The interproximal contact area 12 between two teeth T is the area to be flossed in all illustrations. The head unit consists of the assembly of the biting block FIG A and the flossing element FIG B. FIG A illustrates the retractable biting block of the head unit. The collapsible, accordion-like bite block 1. has biting surfaces above 15. where teeth to be flossed T can rest and bite and a base 3. to receive the flossing element FIG B. Laterally, the retractable bite block 1. consists of a fitting for engaging the arms 5. of the flossing element of FIG. B.

The flossing element FIG B consists of two arms 5 attached to the base 6. The two arms 5 hold a span of floss filament 4 across them. The base of the arms consist of attachment holds 7 designed to engage the handle of the device FIG C. at its fork end protrusions 9. Flossing element FIG B is designed to couple biting block of FIG A to become unitary. The engagement is facilitated by the flossing element arm 5. and the base 6. that also consists of a protrusion 8. that engages the retractable bite block on its sides 2. and its base 3. The base 6. of the flossing element FIG B also provides the biting surface for the opposing teeth to rest and bite. The flossing element FIG B does not retract with the biting block FIG A as it is rigid in all dimensions.

The handle of the device consists of a fork at one end with protrusions 9 to accept the head unit, specifically to the female engagement hold 7 of the flossing element B. The head unit may pivot at the handle attachment 9 for convenience in holding the device. The other end is the handle 11 that may contain power supply and mechanisms for the automated variation of the device. The neck of the handle 10 joins handle 11 with the fork end. The neck of the handle 10 may flex and remain flexed in any angle to allow user to have the flexibility of better adaptation to different teeth.

According to the invention, the head unit consisting of biting block A that is retractable couples with a flossing element B of fixed dimension. The handle C attaches to the head unit A+B illustrated in FIG D. The assembly of the device is not the main focus of the invention. It is an example of one method of fabrication.

Examining more closely at the functional head unit of the device, the cross sectional view of one example of the internal working mechanism is illustrated in FIG E and FIG F. The heart of the internal working mechanism consists of a spring or spring-like object 13 that holds the head unit in the protracted rest position FIG E. Paying closer attention to the position of the flossing filament 4 in relation to the upper biting surface of the head unit 15, they are in close proximity at the protracted/rest state. User of the device would position the head unit such that the floss element and filament is centered between two teeth T with contact area 12 directly over. During function, as teeth T bite down, the spring 13 compresses under tension in FIG F. The accordion-like biting block of the head unit follows suit and shortens under compression from the teeth in FIG F. Smaller protrusions 14 from the top and base of the biting block 1 prevents over compression of the spring as they block further compression beyond a determined limit. At the compressed state, note that the position of the flossing filament 4 in relation to the upper biting surface of the head unit 15, they distant themselves as the biting block shortens, thereby exposing the floss filament 4 to push through the contact area 12 between teeth T.

In reference to FIG G, in actual practice, user holds the handle 11 to position the floss element 12 of the head unit between two teeth to be flossed. At rest, the biting block 1 in its protracted state is positioned between upper and lower teeth. The floss filament 12 is positioned to enter the interproximal area. As the upper and lower teeth come together on bite FIG H, the biting block 1 of the head unit compresses but the arms of the flossing element 5 remain same in height and thereby exposes the floss filament from the biting block. Exposing the flossing filament forces the floss into the contact area and into the embrasure space thereby flosses between those teeth. Reversely, as the bite relaxes, the spring returns to the uncompressed state and thereby returns the biting block to increase in height and thereby pull the floss filament back out of the contact area, FIG G. This completes the task of breaking the contact area of flossing as in prevention of interproximal decay.

Alternatively, a mechanical version of this flossing device can be made. An automatic dental flossing device facilitates the passing of the flossing filament through the contact areas between teeth using electrical power. The accordion-like structure of the head unit attaches a floss filament bow of fixed dimension which attaches to a handle as previously described. As the head unit automatically retracts, the fixed dimension of the flossing element exposes itself because it does not retract with the rest of the head unit. The filament is allowed to enter the interproximal contact. With the assistance of a electrical powered mechanism within the handle and head unit, the flossing head returns to original shape, thereby decreasing the exposure of the flossing filament and is removed from the contact area and out of the embrasure space. This allows not only single handed operation of flossing but also allows users who are not able to exert the force necessary for flossing. The task of flossing has been diverted to electrical power than manual in this variation.

The flossing element may carry the floss filament that is coated with a variety of flavors or medicinal important substances such as fluoride or chlorohexidine. The floss element may be of single use or multiuse. The floss filament may be replenish-able.

I claim:

1. A dental flossing device comprising of
An elongated handle
With a retractable head unit on which upper and lower teeth rests
A floss element of fixed dimensions that attaches/couple the retractable head unit comprised of a base and two arms at which the ends hold a length of floss filament under tension
A locking mechanism that keeps the base of the floss element fixed to the base of the retractable head unit.
A locking and pivoting mechanism that attaches the elongated handle to the head assembly

2. The dental flossing device of claim 1 including a spring or any mechanism that has the retractable function of a spring inside the retractable head unit that returns the said head unit to original shape after retraction.

3. The dental flossing device of claim 1 including the handle and flossing element with a base but without the retractable head unit.

4. The dental flossing device of claim 1 including the retractable head unit that is reusable/multiuse.

5. The dental flossing device of claim 1 including an attachment that allows a separate vibration motion handle to be attached to the head unit/floss element assembly.

6. The dental flossing device of claim 1 including a sliding mechanism in between the biting platform and the flossing element base to facilitate the adaptation or “hugging” of the flossing filament to tooth/root surfaces.

7. The dental flossing device of claim 1 including a floss element that is of single use

8. The dental flossing device of claim 1 including a floss element that replenishes new lengths of floss in between floss holding arms.

9. The dental flossing device of claim 1 including the floss element and filament is fixed onto the head unit which can be fixed or detachable to the base handle.

10. The dental flossing device of claim 1 including a handle with a bendable flexible neck.

11. A variation of the dental flossing device of claim 1 with a fixed biting base unit and the floss element holding arms retract and protract.

12. The dental flossing device of claim 1 including the flossing element consists of a connector instead of a platform for biting that joins the two arms that hold the floss filament forming a bow-like construction.

13. The dental flossing device of claim 1 including the floss element and or filament consists of different colors, scents, flavors, materials, medicinal coatings such as fluoride and chlorohexidine.

14. An automatic dental flossing device comprising of
An electric powered body
With a retractable head unit on which upper and lower teeth rest and press
A floss element of fixed dimensions that attaches to the retractable head unit comprised of a base and two arms at which the ends hold a floss filament
A locking mechanism that keeps the base of the floss element fixed to the base of the retractable head unit.

15. The automatic dental flossing device of claim 14 including a coupling or motorized mechanism that allows the retractable head to be powered by the electric powered body.

16. The automatic dental flossing device of claim 14 including an electric element that delivers vibration motion to the flossing element and filament with or without a retractable head unit installed.

17. The automatic dental flossing device of claim 14 including a sliding element between the biting platform and the flossing element base to facilitate the adaptation or “hugging” of the flossing filament to tooth/root surfaces.

18. The automatic dental flossing device of claim 14 including a spring mechanism inside the retractable head unit that returns the said unit to original shape.

19. The automatic dental flossing device of claim 14 including an inflatable mechanism inside the retractable head unit that returns the said unit to original shape.

20. The automatic dental flossing device of claim 14 including a band of non-elastic material and a channel in which the band fits in close proximity such that the electric body pulls and pushes the band within the channel to retract and protract the retractable head unit.

21. The automatic dental flossing device of claim 14 including a floss element that is of single use

22. The automatic dental flossing device of claim 14 including a floss element that replenishes new lengths of floss in between floss holding arms.

23. The automatic dental flossing device of claim 14 including an attachment in which the electric body/handle can detach from the bite head unit for exchangeability from wear or identification of individual head units with shared handles.

24. The automatic dental flossing device of claim 14 including the floss element and filament is fixed onto the head unit which can be fixed or detachable to the base handle.

25. The variation of the automatic dental flossing device of claim 14 with a fixed biting base unit and the floss element holding arms retract and protract.
